(19) United States
(12) Patent Application Publication
(10) Pub. No.: US 2022/0389219 A1
(43) Pub. Date: Dec. 8, 2022

(54) IONIC SILYLATED COPOLYURETHANE AND MASTIC COMPOSITION COMPRISING SAME

(71) Applicant: BOSTIK SA, COLOMBES (FR)

(72) Inventors: Boris COLIN, VENETTE (FR); Régis GUILLOTTE, VENETTE (FR)

(21) Appl. No.: 17/771,063

(22) PCT Filed: Oct. 21, 2020
(86) PCT No.: PCT/FR2020/051902

§ 371 Date: Apr. 22, 2022

(30) Foreign Application Priority Data
Oct. 24, 2019 (FR) FR1911896

(51) Int. Cl. C08L 75/08; C08G 18/08; C08G 18/28; C08G 18/34; C08G 18/48; C08G 18/10; C08G 18/22; C09J 175/08

(52) U.S. Cl. CPC C08L 75/08; C08G 18/0823; C08G 18/289; C08G 18/285; C08G 18/348; C08G 18/4825; C08G 18/10; C08G 18/227; C09J 175/08; C08G 2190/00; C08G 2170/00

(57) ABSTRACT

1) Ionic silylated copolyurethane of formula:

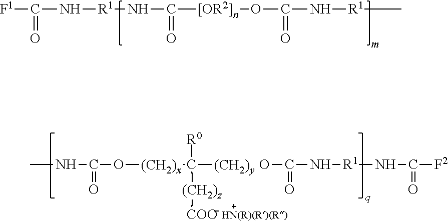

in which R¹ is a hydrocarbon radical; R² is a C2-C4 alkylene; n is an integer such that the molecular mass of —[OR²]ₙ is 2500-20 000 g/mol; R^{∘} is H or C1-C18 alkyl; R, R′ and R″ are a hydrocarbon-based radical; x and y are integers from 1 à 8; z is an integer from 0 to 8; m and q are an integer of greater than or equal to 1, such that q/m ranges from 0.04 to 20; F¹ is a radical of formula (IIa) and F² is a radical of formula (IIb):

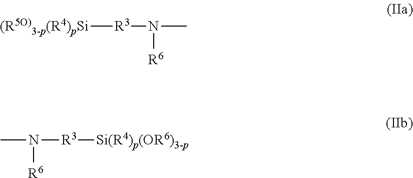

in which R³ is methylene or n-propylene; R⁴ and R⁵ are methyl or ethyl; p is equal to 0 or 1; R⁶ is a C1-C4 alkyl.

2) Process for preparing copolyurethane 1), comprising:
(i) polyaddition between a polyisocyanate, a polyether diol and a carboxylic diol;
(ii) neutralization of the product formed with the amine N(R)(R′)(R″); then
(iii) reaction with an aminosilane derived from a secondary amine.

3) Composition, usable as sealant and/or adhesive, comprising copolyurethane 1) and a filler.

### FIELD OF THE INVENTION

The present invention relates to a novel silylated polyurethane, more specifically having alkoxysilane end groups, and also to a process for preparing same. It also relates to a crosslinkable composition, usable as adhesive and/or sealant, comprising said polyurethane and to a process for assembling two substrates employing said composition.

### TECHNICAL BACKGROUND

In particular on account of their mechanical properties and their affinity for various materials, sealants are widely used both in the construction field and for certain industrial applications.

For instance, they are employed for the assembly of substrates of differing nature, for example metal or concrete substrates, by forming an adhesive joint between the substrates which is both solid and cohesive.

Among its advantageous mechanical properties, the adhesive joint thus formed therefore exhibits a great solidity, indicated by a high resistance to deformation. It also exhibits flexibility (or elasticity) which enables it to adapt to the relative movements of the substrates that it joins, for example under the effect of the dimensional variations induced by changes in temperature or else under the effect of mechanical stresses to which the assembly may be subjected during its lifetime.

The resistance to deformation of a sealant is often quantified, in practice, by the breaking stress (expressed in Pa). The latter is defined simply, in a tensile test on a test specimen consisting of said sealant, as being the stress that needs to be applied to said test specimen in order to achieve breakage thereof.

The elasticity of a sealant for its part is generally represented by a measurement of the elongation at break (expressed in %), which is defined in the above-mentioned tensile test as the elongation measured for said test specimen at the moment at which it breaks.

The sealants most prevalent on the market take the form of compositions which comprise, generally in combination with a mineral filler, a moisture-crosslinkable prepolymer having a chemical structure provided with reactive isocyanate or alkoxysilane groups, these generally being end groups. The reaction of these reactive groups with water originating from the moisture in the air or from the substrates to be assembled, at the moment of use of the sealant, is called the crosslinking reaction.

It is the accomplishment of this reaction, after a period of time referred to as the crosslinking time, which enables the creation of a solid three-dimensional network which confers the desired mechanical properties on the adhesive joint thus formed.

The moisture-crosslinkable sealant compositions based on prepolymers having alkoxysilane end groups (also referred to as silylated sealants) have the advantage of being free from isocyanates, particularly from monomeric diisocyanates. These compositions thus constitute an alternative, which is preferred from a toxicological viewpoint, to the compositions based on polyurethane having isocyanate end groups.

The crosslinking reaction of these silylated sealants takes place, in the presence of moisture, by hydrolysis of the alkoxysilane groups borne by the prepolymer, followed by their condensation to form a siloxane bond (—Si—O—Si—) which unites the prepolymer chains to form a polymer forming a solid three-dimensional network.

The prepolymers included in the silylated sealants may comprise, among various types of main chains, a polyurethane chain, thus forming a silylated prepolyurethane (also referred to simply as polyurethane).

The most well-known silylated polyurethanes are generally prepared by a two-step process. The first step consists in forming a polyurethane having isocyanate end groups, by reacting a poly(propylene glycol) with a diisocyanate. The second step consists in reacting the prepolyurethane thus obtained with an aminosilane comprising an alkoxysilane group so as to obtain a polyurethane main chain which comprises two alkoxysilane end groups each linked to said chain by way of a urea function. Such polyurethanes will be denoted hereinafter with the name “SPUR”.

However, the crosslinking time for these silylated polyurethanes, in particular these SPURs, needs to be accelerated in order to meet the users' needs, and it is obligatory to this end to incorporate a crosslinking catalyst in the sealant compositions comprising these silylated polyurethanes, in particular these SPURs.

Generally, the crosslinking catalyst included in sealant or adhesive compositions based on silylated polymers, in particular on SPURs, is a metal catalyst, and more particularly a tin-based catalyst such as dibutyltin dilaurate (DBTDL), dibutyltin diacetate or dibutyltin bis(acetylacetonate) or dioctyltin bis(acetylacetonate). However, these catalysts are the subject of criticism with respect to their toxicity or to their impact on the environment, which leads to the manufacturers concerned limiting or even avoiding their use, especially when these metal catalysts remain in the adhesive joint once the composition has been crosslinked.

Organic crosslinking catalysts derived from nitrogen-containing heterocycles such as 1,8-diazabicyclo[5.4.0]undec-7-ene (also called DBU) or else 1,5,7-triazabicyclo[4.4.0]dec-5-ene (also called TBD) have been used as an alternative to the metal catalysts, especially to the tin-based catalysts. However, they have the drawback of causing a colour change in the adhesive joint, generally towards yellow, which is attributed to their migration to the surface of said joint.

An aim of the present invention is to overcome the drawbacks of the silylated polyurethanes known in the prior art, in particular the drawbacks of the SPURs.

Another aim of the invention is to propose a silylated polyurethane the crosslinking of which does not require, or substantially does not require, a tin-based catalyst or organic catalyst derived from a nitrogen-containing heterocycle.

Another aim of the invention is to propose a silylated polyurethane which can crosslink in the absence of catalyst.

Another aim of the invention is to propose a sealant composition based on silylated polyurethane which makes it possible, without the addition, or without the substantial addition, of catalyst, to reduce the crosslinking time.

Another aim of the invention is to propose a sealant composition based on silylated polyurethane which has improved mechanical properties.

Another aim of the invention is to propose a sealant composition based on silylated polyurethane which has better adhesion properties on various substrates, in particular on metal substrates.

It has been found that these aims can be achieved, in whole or in part, by means of the silylated copolyurethane having alkoxysilane end groups and of the adhesive composition comprising same, as described hereinbelow.

### DESCRIPTION OF THE INVENTION

The present invention relates firstly to an ionic silylated copolyurethane comprising 2 ureido-alkylene-alkoxysilane end groups and corresponding to the formula (I):

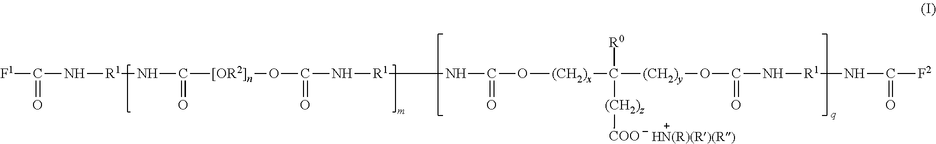

in which:
R¹ represents a divalent hydrocarbon radical comprising from 5 to 45 carbon atoms and which may be aromatic or aliphatic, linear, branched or cyclic, and may include at least one heteroatom chosen from O, S and N;
R² represents a linear or branched divalent alkylene radical comprising from 2 to 4 carbon atoms;
n is an integer such that the number-average molecular mass Mn of the block of formula —[OR²]ₙ— ranges from 2500 to 20 000 g/mol;
R^{∘} represents a hydrogen atom or an alkyl radical comprising from 1 to 18 carbon atoms;
R, R′ and R″, which may be identical or different, each represent a saturated, unsaturated or aromatic hydrocarbon radical, optionally comprising a heteroatom chosen from N, O and S; R, R′ and R″ furthermore being such that the tertiary amine of formula N(R)(R′)(R″) is a linear, branched or cyclic amine or polyamine the number-average molar mass Mn of which ranges from 59 to 6000 g/mol and which has a pKa of greater than 8;
x and y, which may be identical or different, are integers ranging from 1 to 8;
z is an integer ranging from 0 to 8;
m and q, which may be identical or different, are each an integer greater than or equal to 1, such that the ratio q/m is within a range extending from 0.04 to 20, preferably from 0.10 to 13, more preferentially from 0.10 to 5, and even more preferentially from 0.15 to 1,
m, q and n furthermore being such that the number-average molecular mass Mn of the silylated copolyurethane of formula (I) is within a range extending from 3000 to 30 000 g/mol;
F¹ represents a radical of formula (IIa) and F² represents a radical of formula (IIb):

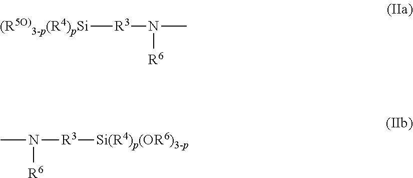

in which:
   R³ represents a linear or branched divalent alkylene radical comprising from 1 to 6 carbon atoms;
   R⁴ represents a linear or branched alkyl radical comprising from 1 to 4 carbon atoms;
   R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms;
   p is equal to 0 or 1; and
   R⁶ represents a phenyl radical, a linear, branched or cyclic alkyl radical comprising from 1 to 6 carbon atoms, or a radical chosen from the radicals:
      of formula (IIc):

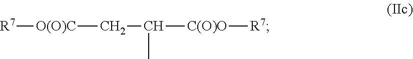

of formula (IId):

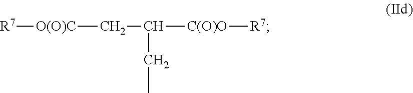

of formula (IIe):

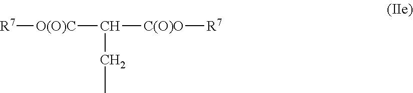

in which R⁷ is a linear or branched alkyl radical comprising from 1 to 6 carbon atoms;
   of formula (IIf):

—CH₂—COO⁻, HN⁺(R)(R′)(R″) (IIf); and
of formula (IIg):

—CH₂—CH₂—COO⁻, HN⁺(R)(R′)(R″) (IIg)

in which R, R′ and R″ are the radicals as defined above.

The ionic silylated copolyurethane of formula (I) advantageously leads to sealant and/or adhesive compositions which have, in the absence of catalyst, in particular in the absence of tin-based catalyst, a reduced crosslinking time compared to the SPURs of the prior art. In addition, the adhesive joint which is formed by the crosslinking in the presence of moisture of an adhesive and/or sealant composition comprising said copolyurethane and at least one mineral filler also has better mechanical properties, and in particular improved resistance to deformation and elasticity, respectively indicated by increased breaking stress and elongation at break. Lastly, the adhesion of said adhesive joint to a support, in particular to a metal support, is strengthened, including in the presence of water and/or moisture, which is very advantageous in certain applications. Mention may for example be made of the durability of a windscreen seal which is caused to be in contact with rainwater.

The various groups, radicals and letters which are included in the formula (I) and which are defined above retain the same definitions throughout the present text, unless otherwise indicated.

In the present text, the average molecular mass Mn is measured by size exclusion chromatography (or SEC), which is also denoted by the term “gel permeation chromatography” (or GPC). The calibration carried out is usually a PEG (PolyEthylene Glycol) or PS (PolyStyrene), preferably PS, calibration.

The following variants of the end groups F¹ and F² of the ionic silylated copolyurethane of formula (I), taken individually or in combination, are particularly preferred:
R³ represents the methylene or n-propylene radical, preferably n-propylene radical;
R⁴ and R⁵, which may be identical or different, each represent the methyl or ethyl radical, preferably methyl radical;
p is equal to 0; and/or
R⁶ represents a linear alkyl radical comprising from 1 to 4 carbon atoms, preferentially n-butyl, or a radical of formula (IIc) in which R⁷ is an alkyl radical comprising from 1 to 3 carbon atoms, R⁷ preferentially being an ethyl radical.

The main chain of the ionic silylated copolyurethane of formula (I) thus consists of a repeat unit repeated m times and a repeat unit repeated q times. It is understood that the distribution of these two units on said main chain is random, and that the copolyurethane of formula (I) is therefore a random copolymer.

Likewise more particularly preferred are the following variants of the main chain, taken individually or in combination with one another or else in combination with the preceding variants described for the end groups F¹ and F².

The radical R¹ which is included in the two repeat units is chosen from one of the following divalent radicals, the formulae of which below show the two free valencies:
a) the divalent radical derived from isophorone diisocyanate (IPDI):

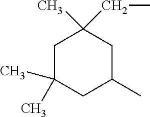

b) the divalent radical derived from dicyclohexylmethane 4,4′- and 2,4′-diisocyanate (HMDI):

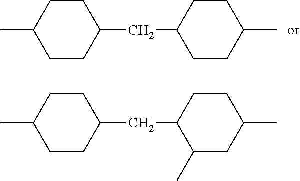

c) the radical derived from toluene 2,4- and 2,6-diisocyanate (TDI):

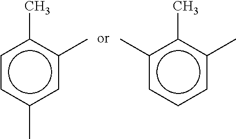

d) the radical derived from diphenylmethane 4,4′- and 2,4′-diisocyanate (MDI):

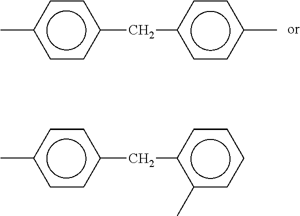

e) the radical derived from m-xylylene diisocyanate (m-XDI):

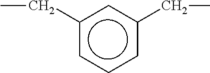

f) the radical derived from hexamethylene diisocyanate (HDI):

—(CH₂)₆—
g) the divalent group derived from a hexamethylene diisocyanate (HDI) allophanate of formula (IVb):

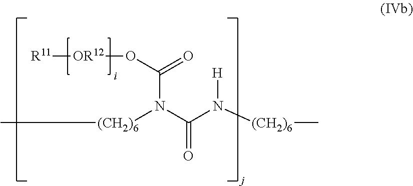

in which:
i is an integer ranging from 2 to 5;
j is an integer ranging from 1 to 2;
R¹¹ represents a saturated or unsaturated, cyclic or acyclic, linear or branched hydrocarbon radical comprising from 6 to 14 carbon atoms;
R¹² represents a divalent propylene group;
i, j, R¹¹ and R¹² being such that the hexamethylene diisocyanate allophanate corresponding to the formula (IVb) comprises a content of isocyanate groups NCO ranging from 12% to 14% by weight, relative to the weight of said allophanate.

Preferably, the radical R¹ is the divalent radical derived from isophorone diisocyanate.

The unit repeated m times corresponds to the polyether block of formula: —[OR²]ₙ—.

According to other embodiments of said unit:
the radical R² advantageously represents a divalent alkylene radical comprising from 2 to 3 carbon atoms, even more preferentially the isopropylene radical; and/or
the integer n is such that the number-average molecular mass Mn of the block of formula —[OR²]ₙ— ranges from 3500 to 12 000 g/mol.

As concerns the unit repeated q times:
R^{∘} represents an alkyl radical comprising from 1 to 4 carbon atoms, preferably a methyl, ethyl or n-propyl radical, even more preferentially a methyl radical;
x and y are identical and equal to 1; and/or
z is equal to 0.

According to an even more preferred variant of said unit, it corresponds to the formula:

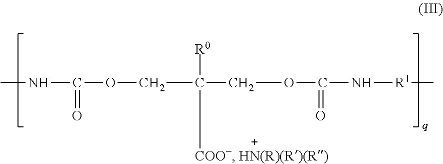

The unit repeated q times thus comprises a pendant anionic carboxylate group the counterion of which is an ammonium of formula: HN⁺(R)(R′)(R″).

According to a preferred variant of said ammonium, R, R′ and R″ are such that the amine of formula N(R)(R′)(R″) is chosen from:
a polyethyleneimine,
a polypropyleneimine,
triethylamine (or TEA, with a pKa equal to 10.75),
1,8-diazabicyclo[5.4.0]undec-7-ene (or DBU) of formula:

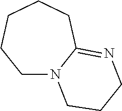 [SMILES: C1CCC2=NCCCN2CC1]

and the pKa of which is equal to 12;
1,4-diazabicyclo [2.2.2]octane (or DABCO), of formula:

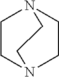

and the pKa of which is equal to 8.87;
1,5-diazabicyclo[4.3.0]non-5-ene (or DBN), of formula:

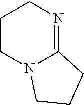

and the pKa of which is equal to 12.

According to a further preferred variant, the pKa of the corresponding amine is greater than or equal to 10.

According to a very particularly preferred variant of said ammonium, R, R′ and R″ each represent an ethyl radical, and said ammonium then corresponds to the formula:

HN⁺(Et)₃

The ionic silylated copolyurethane of formula (I) is generally provided in the form of a viscous liquid and is characterized by a Brookfield viscosity at 23° C. ranging from 10 to 300 Pa·s, preferably from 30 to 200 Pa·s. It is then advantageously easy to use and can be combined with an additional constituent, such as a filler, in order to form an adhesive and/or sealant composition.

The invention also provides a process for preparing the ionic silylated copolyurethane comprising two ureido-alkylene-alkoxysilane end groups and corresponding to the formula (I), said process comprising the sequential steps of:

(i) forming a copolyurethane having —NCO end groups, of formula (IV):

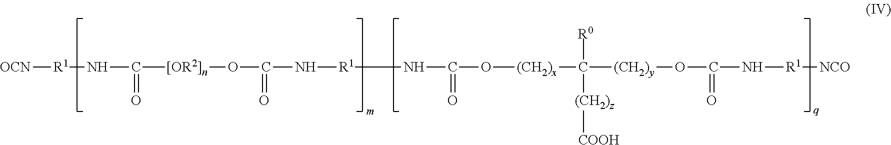

by carrying out a polyaddition reaction between:
a polyisocyanate (A) of formula (IVa): OCN—R¹—NCO (IVa);
a polyether diol (B) of formula (IVb): H—[OR²]ₙ—OH (IVb); and
a carboxylic diol (C) of formula (IVc):

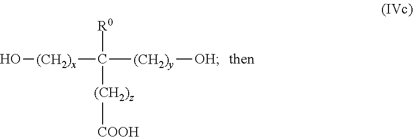

(ii) reacting the copolyurethane of formula (IV) with an amine (D) of formula (IVd):

N(R)(R′)(R″) (IVd)

to form an ionic copolyurethane having —NCO end groups of formula (V):

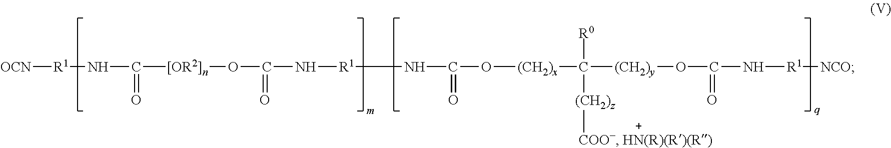

then

(iii) reacting the copolyurethane having —NCO end groups of formula (V) with an aminosilane (E) derived from a secondary amine, of formula (VI):

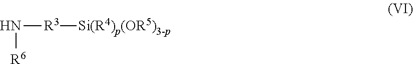

Step (i):

Step (i) employs the polyisocyanate (A) of formula (IVa):

OCN—R¹—NCO (IVa)

in which R¹ represents a divalent hydrocarbon radical comprising from 5 to 45 carbon atoms and which may be aromatic or aliphatic, linear, branched or cyclic, and may include at least one heteroatom chosen from O, S and N.

Preferably, the polyisocyanate (A) of formula (IVa) is such that the radical R¹ is chosen from one of the following divalent radicals, the formulae of which below show the two free valencies:
a) the divalent radical derived from isophorone diisocyanate (IPDI):

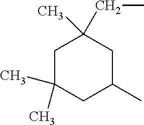

b) the divalent radical derived from dicyclohexylmethane 4,4′- and 2,4′-diisocyanate (HMDI):

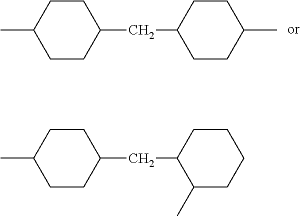

c) the radical derived from toluene 2,4- and 2,6-diisocyanate (TDI):

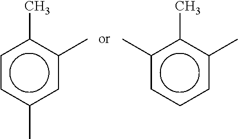

d) the radical derived from diphenylmethane 4,4′- and 2,4′-diisocyanate (MDI):

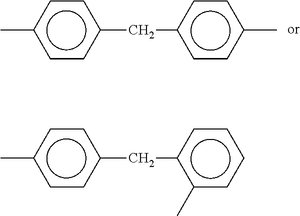

e) the radical derived from m-xylylene diisocyanate (m-XDI):

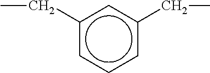

f) the radical derived from hexamethylene diisocyanate (HDI):

—(CH₂)₆—
g) the divalent group derived from a hexamethylene diisocyanate (HDI) allophanate of formula (IVb), as defined above.

Polyisocyanates the radical R¹ of which corresponds to the radicals a) to f) above are well known to those skilled in the art and are widely available commercially. A polyisocyanate the radical R¹ of which corresponds to the divalent group g) above is also sold under the “Tolonate®” name, by the company Vencorex, for example under the name “Tolonate® X FLO 100”.

According to a particularly preferred variant of the process according to the invention, the polyisocyanate (A) is isophorone diisocyanate (IPDI).

Step (i) employs the polyether diol (B) of formula (IVb):

H—[OR²]ₙ—OH (IVb)

in which
R² represents a linear or branched divalent alkylene radical comprising from 2 to 4 carbon atoms; and
n is an integer such that the number-average molecular mass Mn of the block of formula —[OR²]ₙ— ranges from 2500 to 20 000 g/mol.

Preferably, the polyether diol (B) is such that:
the radical R² represents a divalent alkylene radical comprising from 2 to 3 carbon atoms, and/or
the integer n is such that the number-average molecular mass of the block of formula —[OR²]ₙ— ranges from 3500 to 12 000 g/mol.

According to a more preferential variant, the polyether diol (B) is a polypropylene glycol diol for which R² is an isopropylene radical. Such polypropylene glycols are commercially available under the brand name Acclaim® from the company Covestro. Mention may be made, as examples of:
Acclaim® 4200 of molecular mass Mn equal to 4000 g/mol and of N_{OH} equal to 28 mg KOH/g,
Acclaim® 8200 of molecular mass Mn equal to 8000 g/mol and of N_{OH} equal to 13.5 mg KOH/g,
Acclaim® 12200 of molecular mass Mn equal to 12 000 g/mol and of N_{OH} equal to 10 mg KOH/g,
Acclaim® 18200 of molecular mass Mn equal to 18 000 g/mol and of N_{OH} equal to 6.5 mg KOH/g,

The hydroxyl number N_{OH} is the number of hydroxyl functions per gram of diol, expressed in the form of the equivalent number of milligrams of KOH which are used in the quantitative determination of the hydroxyl functions.

Step (i) employs the carboxylic diol (C) of formula (IVc):

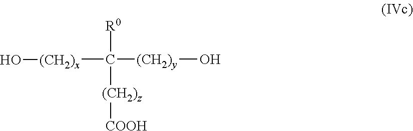

in which:
R^{∘} represents a hydrogen atom or an alkyl radical comprising from 1 to 18 carbon atoms;
x and y, which may be identical or different, are integers ranging from 1 to 8; and
z is an integer ranging from 0 to 8.

According to an advantageous variant of the process according to the invention, a carboxylic diol (C) of formula (IVc) is employed in which:
R represents an alkyl radical comprising from 1 to 4 carbon atoms, preferably a methyl, ethyl or n-propyl radical, even more preferentially a methyl radical;
x and y are identical and equal to 1; and/or
z is equal to 0.

Mention may be made, as specific examples of carboxylic diols (C), of the following α,α-dimethylolalkanoic acids:
2,2-di(hydroxymethyl)propionic acid (or DMPA),
2,2-di(hydroxymethyl)butyric acid,
2,2-di(hydroxymethyl)pentanoic acid.

According to a very particularly preferred embodiment, the carboxylic diol (C) employed in step (i) is 2,2-di(hydroxymethyl)propionic acid, also known as α,α-dimethylolpropionic acid (denoted by way of convenience by the acronym DMPA) of formula:

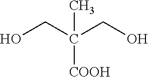

The carboxylic diols (C) of formula (IVc) are prepared according to conventional organic synthesis processes, as are described, for example, in the U.S. Pat. No. 3,412,054 from Union Carbide, and many of them, such as DMPA, are commercially available.

In step (i) of the process according to the invention, the polyisocyanate (A), the polyether diol (B) and carboxylic diol (C) are reacted in amounts corresponding to an excess of the equivalent number of —NCO groups of the polyisocyanate (A) relative to the equivalent number of —OH groups provided by the diols (B) and (C).

Preferably, these amounts correspond to an —NCO/—OH equivalent ratio of between 1.1 and 4.2, preferably between 1.3 and 3.8, more preferentially between 1.5 and 2.

Said ratio is defined as being equal to the equivalent number of —NCO groups of the polyisocyanate (A) divided by the sum of the equivalent numbers of —OH groups provided by the polyether diol (B) and by the carboxylic diol (C).

The amounts by weight of the reactants to be charged into the reactor are determined on the basis of this equivalent —NCO/—OH ratio and from the hydroxyl number N_{OH} of (B) and the molecular masses of (A) and (C).

The relative amounts of the polyether diol (B) and of the carboxylic diol (C) to be introduced into the reactor for reaction in step (i) generally correspond to a number of moles of (C)/number of moles of (B) molar ratio which can vary within a wide range, possibly ranging from 0.04 to 20, preferably from 0.10 to 13, more preferentially from 0.10 to 5, and even more preferentially from 0.15 to 1. In addition, the amount of the carboxylic diol (C) to be charged is advantageously such that the [molar equivalent number of (C)]/[equivalent number of —NCO functions of the copolyurethane of formula (IV) formed] molar ratio is within a range extending from 0.1 to 1.

The polyaddition reaction of step (i) is generally carried out in the presence of a catalyst which may be any catalyst known to those skilled in the art for catalysing the formation of polyurethane by reaction of a polyisocyanate and at least one polyol. Such a catalyst is for example chosen from carboxylates of bismuth and/or zinc. As commercially available examples, mention may be made of Borchi® KAT 315 from the company Borchers GmbH, which is a bismuth neodecanoate; or else Borchi® KAT 15 from this same company, which is a zinc neodecanoate.

Lastly, the polyaddition reaction is carried out, under anhydrous conditions, at a temperature of between 60 and 120° C.

Step (ii):

Step (ii) consists of the reaction of the copolyurethane of formula (IV) obtained in step (i) with an amine (D) of formula (IVd):

N(R)(R′)(R″) (IVd)

and corresponds to the neutralization of the pendant —COOH group which is present in the unit repeated q times of said copolyurethane.

In the formula (IVd):
R, R′ and R″, which may be identical or different, each represent a saturated, unsaturated or aromatic hydrocarbon radical, optionally comprising a heteroatom chosen from N, O and S;
R, R′ and R″ furthermore being such that the tertiary amine (D) of formula N(R)(R′)(R″) is a linear, branched or cyclic amine or polyamine the number-average molar mass Mn of which ranges from 59 to 6000 g/mol and which has a pKa of greater than 8.

According to one embodiment, the tertiary amine (D) is chosen from:
a polyethyleneimine,
a polypropyleneimine,
triethylamine (or TEA, with a pKa equal to 10.75),
1,8-diazabicyclo[5.4.0]undec-7-ene (or DBU) the structural formula of which is:

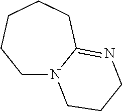 [SMILES: C1CCC2=NCCCN2CC1]

and the pKa of which is equal to 12;
1,4-diazabicyclo[2.2.2]octane (or DABCO), the structural formula of which is:

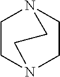

and the pKa of which is equal to 8.87;
1,5-diazabicyclo[4.3.0]non-5-ene (DBN), the structural formula of which is:

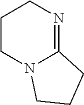

and the pKa of which is equal to 12.

According to a further preferred variant, the pKa of the corresponding amine is greater than or equal to 10.

According to a very particularly preferred variant, the amine (D) is triethylamine (TEA).

According to another preferred variant, the amine (D) is chosen from DBU and DABCO. Such an amine is often incorporated as crosslinking catalyst into a sealant and/or adhesive composition comprising an SPUR. In that case, it has the drawback of leading, after crosslinking of said composition, to a yellowing of the adhesive joint, probably linked to its migration to the surface of said joint. In contrast, the incorporation, in step (ii) of the process according to the invention, of such an amine as an agent for neutralizing the pendant carboxylate group has the advantageous effect of an absence of yellowing of the adhesive joint resulting from the crosslinking of the sealant and/or adhesive composition that comprises the ionic silylated copolyurethane according to the invention prepared by said process. Such an effect is probably linked to the chemical integration of the corresponding quaternary ammonium into the main chain of the copolyurethane according to the invention.

Amine (D) is advantageously introduced in step (ii) in an amount corresponding to a [number of moles of (D)]/[number of moles of the carboxylic diol (C) introduced in step (i)] molar equivalent ratio which is within a range extending from 0.8 to 2.5, preferably from 1 to 2.

The neutralization reaction is carried out at a temperature within a range extending from 20 to 80° C., preferably from 20 to 40° C.

Step (iii):

Step (iii) employs an aminosilane (E) derived from a secondary amine, of formula (VI):

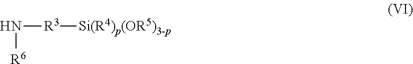

in which:
R³ represents a linear or branched divalent alkylene radical comprising from 1 to 6 carbon atoms;
R⁴ represents a linear or branched alkyl radical comprising from 1 to 4 carbon atoms;
R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms; and
p is equal to 0 or 1;
R⁶ represents a phenyl radical, a linear, branched or cyclic alkyl radical comprising from 1 to 6 carbon atoms, or a radical chosen from the radicals:
   of formula (IIc):

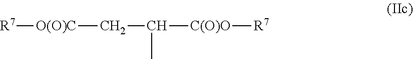

of formula (IId):

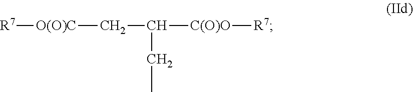

of formula (IIe):

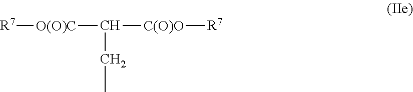

in which R⁷ is a linear or branched alkyl radical comprising from 1 to 6 carbon atoms;
   of formula (IIf):

—CH₂—COO⁻, HN⁺(R)(R′)(R″) (IIf); and
of formula (IIg):

—CH₂—CH₂—COO⁻, HN⁺(R)(R′)(R″) (IIg)

in which R, R′ and R″ are the radicals as defined above.

The aminosilanes of formula (VI) are widely commercially available.

As an example, mention may be made of:
N-(3-(trimethoxysilyl)propyl)butylamine available under the name Dynasylan® 1189 from Evonik, of formula:

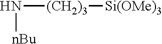

Other aminosilanes o formula (VI) are easily obtained by synthesis from commercial products. This is thus the case for the compound named “aminotriethoxysilane DEM+A1100” hereinbelow, which corresponds to the formula:

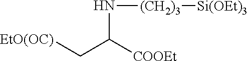

and which is obtained by reacting diethyl maleate with γ-aminopropyltriethoxysilane. The latter compound is available under the name Silquest® A1100 from Momentive and corresponds to the formula:

H₂N—(CH₂)₃—Si(OEt)₃

The aminosilanes of formula (VI) in which R⁶ represents a radical of formula (IIf) or (IIg) may be obtained by neutralization, by means of the amine (D) of formula (IVd), of the silylated compounds substituted by an amino acid that are described in the U.S. Pat. No. 9,567,354 in the name of Shin-Etsu Chemical Co., Ltd.

Preferably, in formula (VI):
R³ represents the methylene or n-propylene radical, preferably n-propylene radical;
R⁴ and R⁵, which may be identical or different, each represent the methyl or ethyl radical, preferably methyl radical;
p is equal to 0; and/or
R⁶ represents a linear alkyl radical comprising from 1 to 4 carbon atoms, preferentially n-butyl, or a radical of formula (IIc) in which R⁷ is an alkyl radical comprising from 1 to 3 carbon atoms, R⁷ preferentially being an ethyl radical.

To form the ionic silylated copolyurethane having ureido-alkylene-alkoxysilane end groups of formula (I), according to the invention, the copolyurethane having —NCO end groups of formula (V) is reacted, in accordance with step (iii), with a substantially stoichiometric amount of the aminosilane (E). The molar amounts of these reactants advantageously correspond to an —NCO/—NH equivalent ratio which is between 0.90 and 1.1, and is preferably equal to about 1.

During this step (iii), reaction of the —NH group of the aminosilane (E) with each of the two —NCO end groups of the copolyurethane of formula (V) leads to the formation of a urea function.

Step (iii) is carried out, likewise under anhydrous conditions, at a temperature within a range extending from 20 to 80° C., preferably from 20 to 40° C.

The present invention also relates to a composition, usable as adhesive and/or sealant, comprising:
at least one ionic silylated copolyurethane having ureido-alkylene-alkoxysilane end groups according to the invention, and
at least one filler.

According to a preferred embodiment, said composition comprises:
from 10% to 50% by weight of said copolyurethane, preferably from 20% to 45% by weight, more preferably from 35% to 45% by weight, and
from 20% to 60% by weight of the filler, preferably from 30% to 55% by weight, more preferably from 40% to 55% by weight;
these weight percentages being expressed on the basis of the total weight of said composition.

The filler(s) which can be used in the composition according to the invention can be chosen from mineral fillers and mixtures of organic fillers and of mineral fillers.

As examples of mineral filler(s) that may be used, use may be made of any mineral filler(s) customarily used in the field of adhesive and/or sealant compositions. These fillers are in the form of particles of varied geometry. They may be, for example, spherical or fibrous or may have an irregular shape.

Preferably, use is made of clay, quartz or carbonate fillers.

More preferentially, use is made of carbonate fillers, such as alkali metal or alkaline earth metal carbonates, and more preferentially calcium carbonate.

These fillers can be natural or treated, for example using an organic acid, such as stearic acid, or a mixture of organic acids consisting predominantly of stearic acid.

Use may also be made of hollow mineral microspheres, such as hollow glass microspheres, and more particularly those made of calcium sodium borosilicate or of aluminosilicate.

As examples of organic filler(s) that may be used, use may be made of any organic filler(s) and in particular polymeric filler(s) customarily used in the field of adhesive and/or sealant compositions.

Use may be made, for example, of polyvinyl chloride (PVC), polyolefins, rubber, ethylene/vinyl acetate (EVA) or aramid fibers, such as Kevlar®.

Use may also be made of hollow microspheres made of expandable or non-expandable thermoplastic polymer. Mention may notably be made of hollow microspheres made of vinylidene chloride/acrylonitrile.

Preferably, use is made of PVC.

The mean particle size of the filler(s) which can be used is preferably less than or equal to 10 microns, more preferentially less than or equal to 3 microns, in order to prevent them from settling in the adhesive and/or sealant composition according to the invention during its storage.

The mean particle size is measured for a volume particle size distribution corresponding to 50% by volume of the sample of particles which is analyzed. When the particles are spherical, the mean particle size corresponds to the median diameter (D50 or Dv50), which corresponds to the diameter such that 50% of the particles by volume have a size which is smaller than said diameter. In the present application, this value is expressed in micrometres and determined according to the standard NF ISO 13320-1 (1999) by laser diffraction on an appliance of Malvern type.

According to one embodiment, the composition according to the invention may additionally comprise at least a moisture-absorbing agent, an adhesion-promoting agent, a plasticizing agent and/or a rheology agent.

Appropriate moisture-absorbing agents (or desiccants) are in particular alkoxysilanes such as trialkoxysilanes (particularly trimethoxysilanes) and alkoxysilanes containing an amino, mercapto or epoxy group. Examples that may be mentioned include vinyltrimethoxysilane (or VTMO), gamma-glycidyloxypropyltrimethoxysilane, N-beta-(aminoethyl)-gamma-aminopropyltrimethoxysilane, aminopropyltrimethoxysilane, trimethoxymethylsilane. These compounds are commercially available; for example, vinyltrimethoxysilane is available under the trade name Dynasylan® VTMO from the company Evonik. Such an agent advantageously extends the storage life of the composition according to the invention during storage and transportation before its use. An amount of moisture-absorbing agents in the composition of between 0.5% and 5% by weight, based on the weight of said composition, will generally be suitable.

Some of these compounds may also act as adhesion-promoting agent, particularly the trialkoxysilanes containing an amino, mercapto or epoxy group. An example that may be mentioned is N-(3-(trimethoxysilyl)propyl)ethylenediamine sold under the name GENIOSIL® GF9 by the company WACKER. An amount of from 0.5% to 2% by weight (based on the weight of said composition) will generally be appropriate.

As an example of a plasticizing agent that may be used, use may be made of any plasticizing agent customarily used in the field of sealant and/or adhesive compositions.

Preferably, use is made of:
diisodecyl phthalate (DIDP)
an ester of alkylsulfonic acid and of phenol, as sold under the name Mesamoll® by the company Lanxess,
diisononyl 1,2-cyclohexanedicarboxylate, as sold under the name Hexamoll DINCH® by the company BASF.

The plasticizing agent is generally included in the composition according to the invention in an amount of from 5% to 20% by weight, preferably from 10% to 15% by weight, based on the weight of said composition.

The rheology agents that may be used are any rheology agents customarily used in the field of adhesive and/or sealant compositions.

Preferably, use is made of one or more rheology agents chosen from thixotropic agents, and more preferentially from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica,
urea derivatives resulting from the reaction of an aromatic diisocyanate monomer, such as 4,4′-MDI, with an aliphatic amine, such as butylamine. The preparation of such urea derivatives is described in particular in the application FR 1 591 172.

The total content of rheology agent(s) that may be included in the composition according to the invention may vary from 1% to 40% by weight, preferably from 5% to 30% by weight, more preferentially from 10% to 25% by weight, based on the weight of said composition.

The sealant and/or adhesive composition according to the invention is preferably stored in an anhydrous environment, for example in a hermetic packaging where said composition is protected from moisture and preferably protected from light.

The present invention also relates to a process for preparing a sealant and/or adhesive composition according to the invention, said preparation process comprising a step in which the ingredient(s) possibly present in said composition is/are mixed with a nonionic copolyurethane according to the invention, at a temperature of less than or equal to 50° C., preferably ranging from 5 to 45° C., and better still ranging from 20 to 30° C.

The addition and the mixing are carried out under anhydrous conditions.

Another subject of the present invention is an article comprising the adhesive and/or sealant composition according to the invention in a hermetic packaging protected from air. The hermetic packaging is preferably a polyethylene bag or a polyethylene cartridge provided with a cap.

Lastly, the invention relates to a process for assembling two substrates, comprising:
coating the composition according to the invention at ambient temperature, in the form of a layer of a thickness between 0.2 and 5 mm, preferably between 1 and 3 mm, onto at least one of the two substrates to be assembled; then
effectively bringing the two substrates into contact.

The appropriate substrates are, for example, inorganic substrates, such as glass, ceramics, concrete, metals or alloys (such as aluminium, steel, non-ferrous metals and galvanized metals); or else organic substrates such as wood, plastics, such as PVC, polycarbonate, PMMA, polyethylene, polypropylene, polyesters or epoxy resins; substrates made of metal and composites coated with paint (as in the motor vehicle field).

The examples that follow are given purely by way of illustration of the invention and should not be interpreted in order to limit the scope thereof.

### Example A (Comparative)

1) Preparation of a SPUR a Having Trimethoxysilane End Groups:

1^{st} Step: Synthesis of a Polyurethane Having Isocyanate End Groups

412 g of polypropylene glycol Acclaim® 4200 having a hydroxyl number N_{OH} equal to 28 mg KOH/g (corresponding to a number of —OH functions equal to 205.6 mmol) is introduced into a 1 litre reactor equipped with a stirrer, heating means and a thermometer and connected to a vacuum pump.

The mixture is left under vacuum for 2 hours at 110° C. for dehydration.

The reactor is then cooled to 90° C. in order to introduce, under nitrogen:
44.4 g of isophorone diisocyanate (JPDI) of molar mass equal to 222.3 g/mol, i.e. a number of —NCO functions equal to 399.4 mmol; and
0.15 g of the catalyst Borchi® KAT 315 (bismuth neodecanoate).

The amounts of reactants introduced correspond to an —NCO/—OH molar equivalent ratio equal to 1.94.

The mixture is kept stirring until an NCO weight percentage of 1.7% is reached, corresponding to a number of —NCO functions equal to 184.6 mmol.

2^{nd} Step: Reaction with an Aminotrimethoxysilane

Next, 43.5 g of the aminosilane (N-(3-(trimethoxysilyl)propyl)butylamine) (Dynasylan® 1189) of molar mass equal to 235.4 g/mol, corresponding to a number of —NH-functions equal to 184.8 mmol, is added to the reaction medium.

The —NCO/—NH— molar equivalent ratio is equal to 1.

The combined mixture is heated to 70° C. and kept stirring until the reaction is complete, i.e. until the band characteristic of the —NCO functions is no longer detectable by infrared spectroscopy.

Approximately 500 g of silylated polyurethane (denoted hereinafter with SPUR A) are obtained, which product is packaged in aluminium cartridges protected from moisture.

The Brookfield viscosity at 23° C. of SPUR A is 52 Pa·s.

2) Preparation of Two Sealant Compositions A and A′ Comprising SPUR A:

Sealant A is prepared by simple mixing in a rapid mixer, the composition of sealant A being indicated hereinbelow on a weight basis:
41.8% by weight of SPUR A;
53.8% by weight of precipitated calcium carbonate with a mean particle size of less than 1 μm (Calofort SV, available from the company Specialty Minerals);
2.8% by weight of vinyltrimethoxysilane (VTMO), as moisture-absorbing agent;
1.4% by weight of N-(3-(trimethoxysilyl)propyl)ethylenediamine (sold under the name GENIOSIL® GF9 by WACKER) as adhesion-promoting agent;
0.2% by weight, as crosslinking catalyst, of dioctyltin bis(acetylacetonate) (TibKat 223, available from TIB Chemicals)

A 2^{nd} variant of this sealant composition, i.e. A′, is prepared without the crosslinking catalyst, and with minimal adjustment of the proportions of the other ingredients.

The sealant composition obtained is left stirring under a reduced pressure of 20 mbar for 15 minutes before being packaged in a polyethylene cartridge to avoid the presence of moisture.

The composition is then subjected to the following tests.

Measurement of the Crosslinking Time:

The crosslinking time is measured by determining the skinning time.

To this end, a bead of sealant (approximately 10 cm long and approximately 1 cm in diameter) is first deposited on a cardboard support. Then, using the tip of a pipette made from low-density polyethylene (LDPE), the surface of the sealant is touched every minute for a maximum of 2 hours in order to determine the exact time at which the skin forms on the surface. This test is performed under controlled conditions of humidity and temperature (23° C. and 50% relative humidity).

The result obtained for each of the compositions A and A′ is expressed in minutes and indicated in Table 2.

Measurement of the Breaking Stress and the Elongation at Break by Tensile Testing:

The principle of the measurement consists in drawing, in a tensile testing device, the movable jaw of which moves at a constant rate equal to 100 mm/minute, a standard test specimen consisting of the crosslinked sealant composition and in recording, at the moment when the test specimen breaks, the tensile stress applied (in MPa) and also the elongation of the test specimen (in %).

The standard test specimen is dumbbell-shaped, as illustrated in the international standard ISO 37. The narrow part of the dumbbell used has a length of 20 mm, a width of 4 mm and a thickness of 3 mm.

To prepare the dumbbell, the composition packaged as described above is extruded at ambient temperature into an appropriate mould and is left to crosslink for 14 days under standard conditions (23° C. and 50% relative humidity).

This determination is repeated over 5 dumbbells and the mean obtained is indicated in Table 2.

Failure Test on Aluminium Support by Shear Testing:

Two rectangular aluminium test specimens are used having the dimensions: 100×25×1.25 mm. The sealant composition is applied onto one of the two test specimens over a surface area of 25×10 mm in the form of a layer of thickness approximately 250 μm. The second test specimen is then placed so as to cover the 1^{st} test specimen thus coated.

The assembly of the two test specimens is held by clips for 14 days under standard conditions (23° C. and 50% relative humidity) for complete crosslinking of the sealant.

The assembly is subjected to a shear test using a universal testing machine operating at a rate of 10 mm/minute until separation of the two test specimens and failure of the assembly.

The effectiveness of the adhesive-support bond is then evaluated by the type of failure observed: adhesive failure (AF) corresponding to a separation between the adhesive joint and support or else cohesive failure (CF), corresponding to a failure in the bulk of the adhesive joint.

The test is repeated 3 times and the mean of the shear stresses corresponding to failure of the assembly is reported in Table 2, as is the type of failure observed.

Failure Test on Aluminium by Shear Testing after Wet Poultice:

An assembly of two test specimens held together by the sealant composition is produced by proceeding as above.

Said assembly is also held by clips for 14 days under standard conditions (23° C. and 50% relative humidity) for complete crosslinking of the sealant.

At the same time, strips of cotton wool are cut and weighed.

Next, the assembly of the two test specimens obtained after complete crosslinking is deposited on a strip of cotton wool and wrapped in same. Then, the assembly is introduced into a first polyethylene bag in which a mass of deionized water equal to 10 times that of the cotton wool is added, taking care to uniformly wet the cotton wool by pressing. The polyethylene bag is closed by welding using welding tongs. In order to ensure a perfect seal, the assembly is introduced into a second bag which is also welded like the first.

After resting in a chamber at 70° C. for 7 and 14 days, respectively, the assembly of the two test specimens is removed from the bag and from the cotton wool and then placed in a chamber at −20° C. for 2 h.

The assembly is lastly placed at ambient temperature for 2 to 4 h in order to perform the shear test under conditions identical to those described for the shear test of the preceding test.

The results obtained are indicated in Table 2.

### Example 1 (According to the Invention)

1) Preparation of an Ionic Silylated Copolyurethane Having Trimethoxysilane End Groups:

Step (i): Synthesis of a Copolyurethane Having Isocyanate End Groups

The following are introduced into a 1 litre reactor equipped with a stirrer, heating means and a thermometer and connected to a vacuum pump:
402.6 g of polypropylene glycol Acclaim® 4200 having a hydroxyl number N_{OH} equal to 28 mg KOH/g, corresponding to a number of —OH functions equal to 201 mmol; and
2.5 g of DMPA (molar mass equal to 134.13 g/mol) corresponding to a number of —OH functions equal to 37.2 mmol

The mixture is left under vacuum for 2 hours at 110° C. for dehydration.

The reactor is then cooled to 90° C. in order to introduce, under nitrogen:
47.8 g of isophorone diisocyanate (JPDI) of molar mass equal to 222.3 g/mol, i.e. a number of —NCO functions equal to 430 mmol; and
0.15 g of the catalyst Borchi® KAT 315 (bismuth neodecanoate).

The amounts of reactants introduced correspond to an —NCO/—OH molar equivalent ratio equal to 1.80.

The mixture is kept stirring until an NCO weight percentage of 1.7% is reached, corresponding to a number of —NCO functions equal to 183.3 mmol.

Step (ii): Synthesis of an Ionic Copolyurethane Having Isocyanate End Groups

At 40° C., 1.9 g of TriEthylAmine (TEA) (molar mass equal to 101.19 g/mol), i.e. 18.8 mmol, is then introduced into the reaction medium and the mixture is left stirring for 1 hour.

Step (iii): Synthesis of the Ionic Silylated Copolyurethane

Lastly, 43.2 g of the aminosilane (N-(3-(trimethoxysilyl)propyl)butylamine) (Dynasylan® 1189) of molar mass equal to 235.4 g/mol, corresponding to a number of —NH— functions equal to 183.5 mmol, is added to the reaction medium.

The —NCO/—NH— molar equivalent ratio is equal to 1.

The combined mixture is heated to 40° C. and kept stirring until the reaction is complete, i.e. until the band characteristic of the —NCO functions is no longer detectable by infrared spectroscopy.

Approximately 500 g of ionic silylated copolyurethane are obtained, which product is packaged in aluminium cartridges protected from moisture.

The Brookfield viscosity at 23° C. of the ionic silylated copolyurethane is 80.35 Pa·s.

2) Preparation of a Sealant Composition without Crosslinking Catalyst:

This composition is prepared by repeating example A 2), except that, in the sealant composition A′, SPUR A is replaced with the ionic silylated copolyurethane having trimethoxysilane end groups prepared according to 1).

The process is performed as indicated in example A for the measurement of the crosslinking time, for the measurement of the breaking stress and of the elongation at break by tensile testing, for the failure test on aluminium support by shear testing (without and after wet poultice).

The results are indicated in Table 2.

TABLE 1
Preparation of an ionic silylated
copolyurethane having trimethoxysilane end groups

| Step | Ingredients | Example 1 | Example 2 | Example 3 |
|---|---|---|---|---|
| (i) | Acclaim ® 4200 (in g) | 402.6 | 283.2 | 283.2 |
| | DMPA (in g) | 2.5 | 1.8 | 1.8 |
| | DMPA/Acclaim ® | 0.18 | 0.19 | 0.19 |
| | 4200 molar ratio | | | |
| | IPDI (in g) | 47.8 | 33.1 | 33.1 |
| | Borchi ® KAT | 0.15 | 0.10 | 0.10 |
| | 315 (in g) | | | |
| | —NCO/—OH | 1.80 | 1.77 | 1.77 |
| | equivalent molar ratio | | | |
| (ii) | TEA (in g) | 1.9 | — | — |
| | DABCO (in g) | — | 1.6 | — |
| | DBU (in g) | — | — | 2 |
| | —NCO/—OH | 1.00 | 0.98 | 0.98 |
| | equivalent molar ratio | | | |
| (iii) | Dynasylan ® 1189 (in g) | 43.2 | 30.3 | 30.3 |
| | —NCO/—NH- | 1 | 1 | 1 |
| | molar equivalent ratio | | | |

| | | | |
|---|---|---|---|
| Brookfield viscosity | 80.35 | 78.00 | 80.40 |
| at 23° C. (in Pa · s) | | | |

TABLE 2
Results relating to the silylated sealants

| | A | A′ | Ex. 1 | Ex. 2 | Ex. 3 |
|---|---|---|---|---|---|
| Crosslinking | 10 | 105 | 50 | 40 | 20 |
| time (min) | | | | | |
| Tensile test- | 3.5 | 3.7 | 4.7 | 4.7 | 3.9 |
| Breaking stress | | | | | |
| (MPa) | | | | | |
| Tensile test- | 52 | 41 | 65 | 73 | 80 |
| Elongation | | | | | |
| at break (%) | | | | | |
| Shear test (without | 1.7 | * | 3.3 | * | * |
| poultice)- | (CF) | | (CF) | | |
| Breaking stress | | | | | |
| (MPa) | | | | | |
| Shear test (after | 1.2 | * | 2.1 | * | * |
| poultice 7 d)- | (between | | (CF) | | |
| Breaking stress | AF and CF) | | | | |
| (MPa) | | | | | |
| Shear test (after | 1.2 | * | 2.0 | * | * |
| poultice 14 d)- | (between | | (CF) | | |
| Breaking stress | AF and CF) | | | | |
| (MPa) | | | | | |

* Not determined

### Examples 2 and 3 (According to the Invention)

1) Preparation of an Ionic Silylated Copolyurethane Having Trimethoxysilane End Groups:

Example 1 is repeated with the amounts of ingredients indicated in Table 1.

The Brookfield viscosity at 23° C. of the ionic silylated copolyurethane obtained is likewise indicated in Table 1.

2) Preparation of a Sealant Composition without Crosslinking Catalyst:

This composition is prepared by proceeding as for Example 1.

The results obtained are likewise indicated in Table 2 hereinafter.

It is observed that, in the absence of crosslinking catalyst, the sealant compositions of Examples 1-3 have a significantly reduced crosslinking time compared to that of the composition of SPUR A′. Moreover, the breaking stress and the elongation at break measured in the tensile test are also markedly improved.

As concerns the sealant of Example 1, there also appears to be a higher breaking stress in the shear test relative to the sealant A, resulting in a marked improvement of the adhesion on aluminium which is also observed in the presence of water.

### Example B (Comparative)

1) Preparation of a SPUR B Having Triethoxysilane End Groups:

Example A 1) is repeated, except that, in the 2^{nd} step, the introduction of 43.5 g of Dynasylan® 1189 is replaced with 72.7 g of the aminopropyltriethoxysilane DEM+A1100 as defined above, of molar mass 393.58 g/mol. The corresponding —NCO/—NH— molar equivalent ratio is equal to 1.

Approximately 530 g of silylated polyurethane (denoted hereinafter with SPUR B) are obtained, which product is packaged in polyethylene cartridges protected from moisture.

The Brookfield viscosity at 23° C. of SPUR B is 60 Pa·s.

2) Preparation of Two Sealant Compositions B and B′ Comprising SPUR B:

Example A 2) is repeated, replacing SPUR A and A′ by SPUR B and B′, respectively.

The results obtained for the crosslinking time and for the tensile test are reported in Table 4.

### Examples 4-6 (According to the Invention)

1) Preparation of an Ionic Silylated Copolyurethane Having Triethoxysilane End Groups:

Example 1 is repeated, except that, in step (iii), the aminosilane DYNASYLAN® 1189 is replaced with the aminotriethoxysilane DEM+A1100 of Example B, and that the amounts of ingredients indicated in Table 3 are used.

The Brookfield viscosity at 23° C. of the ionic silylated copolyurethane obtained is likewise indicated in Table 3.

2) Preparation of a Sealant Composition without Crosslinking Catalyst:

This composition is prepared by proceeding, mutatis mutandis, as for Example 1.

The results obtained are indicated in Table 4.

TABLE 3
Preparation of an ionic silylated
copolyurethane having triethoxysilane end groups

| Step | Ingredients | Example 4 | Example 5 | Example 6 |
|---|---|---|---|---|
| (i) | Acclaim ® 4200 (in g) | 224.2 | 222.7 | 247 |
| | DMPA (in g) | 1.5 | 3.1 | 7 |
| | DMPA/Acclaim ® | 0.20 | 0.41 | 0.84 |
| | 4200 molar ratio | | | |
| | IPDI (in g) | 29 | 29 | 38.6 |
| | Borchi ® KAT | 0.10 | 0.08 | 0.10 |
| | 315 (in g) | | | |
| | —NCO/—OH | 1.94 | 1.66 | 1.53 |
| | equivalent molar ratio | | | |
| (ii) | TEA (in g) | 2.3 | 4.6 | 10.6 |
| | —NCO/—OH | 2.0 | 1.97 | 2.0 |
| | equivalent molar ratio | | | |
| (iii) | aminotriethoxysilane | 40.9 | 41.3 | 46.6 |
| | DEM + A1100 (in g) | | | |
| | —NCO/—NH- | 1 | 1 | 1 |
| | molar equivalent ratio | | | |

| | | | |
|---|---|---|---|
| Brookfield viscosity | 62.25 | 83.40 | 184.50 |
| at 23° C. (in Pa · s) | | | |

TABLE 4
Results relating to the silylated sealants

| | B | B′ | Ex. 4 | Ex. 5 | Ex. 6 |
|---|---|---|---|---|---|
| Crosslinking | >120 | >120 | >120 | 32 | 20 |
| time (min) | | | | | |
| Tensile test- | 1.9 | * | 2.3 | 2.8 | 5.0 |
| Breaking stress | | | | | |
| (MPa) | | | | | |
| Tensile test- | 57 | * | 50 | 170 | 90 |
| Elongation | | | | | |
| at break (%) | | | | | |

* Not determined

It is observed in Table 4 that, in the absence of crosslinking catalyst, the sealant compositions of Examples 4-6, in the tensile test and compared to the composition of SPUR B, exhibit markedly improved breaking stress and/or elongation at break.

Moreover, examples 5 and 6 also give rise to a considerably reduced crosslinking time which, when it comes to polyurethanes having ethoxysilane end groups that are known to be difficult to crosslink, is particularly advantageous in terms of regulatory constraints.

1-14. (canceled)

15. Ionic silylated copolyurethane comprising 2 ureido-alkylene-alkoxysilane end groups and corresponding to the formula (I): 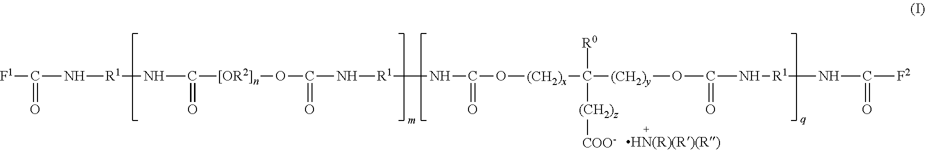
wherein:
R¹ represents a divalent hydrocarbon radical comprising from 5 to 45 carbon atoms and which may be aromatic or aliphatic, linear, branched or cyclic, and may include at least one heteroatom selected from the group consisting of O, S and N;
R² represents a linear or branched divalent alkylene radical comprising from 2 to 4 carbon atoms;
n is an integer such that the number-average molecular mass Mn of the block of formula —[OR²]ₙ— ranges from 2500 to 20,000 g/mol;
R^{∘} represents a hydrogen atom or an alkyl radical comprising from 1 to 18 carbon atoms;
R, R′ and R″, which may be identical or different, each represent a saturated, unsaturated or aromatic hydrocarbon radical, optionally comprising a heteroatom selected from the group consisting of N, O and S; R, R′ and R″ furthermore being such that the tertiary amine of formula N(R)(R′)(R″) is a linear, branched or cyclic amine or polyamine the number-average molar mass Mn of which ranges from 59 to 6000 g/mol and which has a pKa of greater than 8;
x and y, which may be identical or different, are integers ranging from 1 to 8;
z is an integer ranging from 0 to 8;
m and q, which may be identical or different, are each an integer greater than or equal to 1, such that the ratio q/m is within a range extending from 0.04 to 20,
m, q and n furthermore being such that the number-average molecular mass Mn of the silylated copolyurethane of formula (I) is within a range extending from 3000 to 30,000 g/mol;
F¹ represents a radical of formula (IIa) and F² represents a radical of formula (IIb): 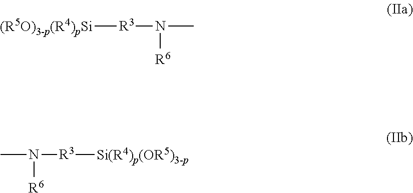
wherein:
R³ represents a linear or branched divalent alkylene radical comprising from 1 to 6 carbon atoms;
R⁴ represents a linear or branched alkyl radical comprising from 1 to 4 carbon atoms;
R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms;
p is equal to 0 or 1; and
R⁶ represents a phenyl radical, a linear, branched or cyclic alkyl radical comprising from 1 to 6 carbon atoms, or a radical chosen from the radicals:
of formula (IIc): 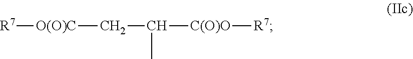
of formula (IId): 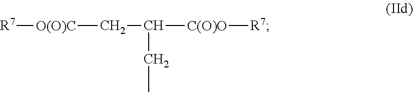
of formula (IIe): 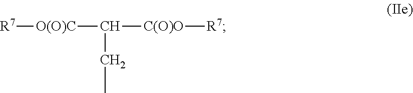
wherein R⁷ is a linear or branched alkyl radical comprising from 1 to 6 carbon atoms;
of formula (IIf):
—CH₂—COO⁻, HN⁺(R)(R′)(R″) (IIf); and
of formula (IIg):
—CH₂—CH₂—COO⁻, HN⁺(R)(R′)(R″) (IIg)

16. Ionic silylated copolyurethane according to claim 15, wherein:
R³ represents the methylene or n-propylene radical;
R⁴ and R⁵ each represent the methyl or ethyl radical;
p is equal to 0; and/or
R⁶ represents a linear alkyl radical comprising from 1 to 4 carbon atoms or a radical of formula (IIc) wherein R⁷ is an alkyl radical comprising from 1 to 3 carbon atoms.

17. Ionic silylated copolyurethane according to claim 15, wherein the radical R¹ is selected from the group consisting of:
a) the divalent radical derived from isophorone diisocyanate (IPDI): 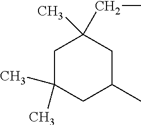
b) the divalent radical derived from dicyclohexylmethane 4,4′- and 2,4′-diisocyanate (HMDI): 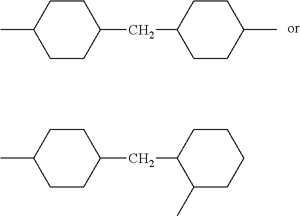
c) the radical derived from toluene 2,4- and 2,6-diisocyanate (TDI): 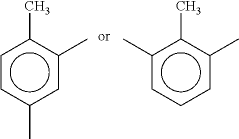
d) the radical derived from diphenylmethane 4,4′- and 2,4′-diisocyanate (MDI): 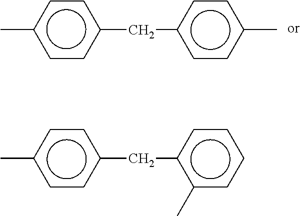
e) the radical derived from m-xylylene diisocyanate (m-XDI): 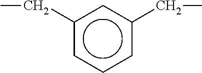
f) the radical derived from hexamethylene diisocyanate (HDI):
—(CH₂)₆—
g) the divalent group derived from a hexamethylene diisocyanate (HDI) allophanate of formula (IVb): 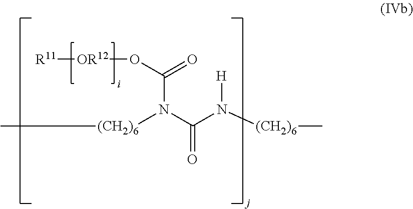
wherein:
i is an integer ranging from 2 to 5;
j is an integer ranging from 1 to 2;
R¹¹ represents a saturated or unsaturated, cyclic or acyclic, linear or branched hydrocarbon radical comprising from 6 to 14 carbon atoms;
R¹² represents a divalent propylene group;
i, j, R¹¹ and R¹² being such that the hexamethylene diisocyanate allophanate corresponding to the formula (IVb) comprises a content of isocyanate groups NCO ranging from 12% to 14% by weight, relative to the weight of said allophanate.

18. Ionic silylated copolyurethane according to claim 15, wherein:
the radical R² represents a divalent alkylene radical comprising from 2 to 3 carbon atoms; and/or
the integer n is such that the number-average molecular mass Mn of the block of formula —[OR²]ₙ— ranges from 3500 to 12,000 g/mol.

19. Ionic silylated copolyurethane according to claim 15, wherein:
R^{∘} represents an alkyl radical comprising from 1 to 4 carbon atoms;
x and y are identical and equal to 1; and/or
z is equal to 0.

20. Ionic silylated copolyurethane according to claim 15, wherein the unit repeated q times corresponds to the formula:

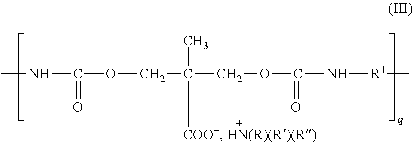

21. Ionic silylated copolyurethane according to claim 15, wherein R, R′ and R″ are such that the amine of formula N(R)(R′)(R″) is selected from the group consisting of:
a polyethyleneimine,
a polypropyleneimine,
triethylamine (or TEA),
1,8-diazabicyclo[5.4.0]undec-7-ene (or DBU), of formula: 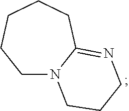 [SMILES: C1CCC2=NCCCN2CC1]
1,4-diazabicyclo[2.2.2]octane (or DABCO), of formula: 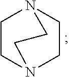
and
1,5-diazabicyclo[4.3.0]non-5-ene (or DBN), of formula:

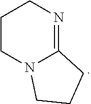

22. Ionic silylated copolyurethane according to claim 15, wherein its Brookfield viscosity at 23° C. ranges from 10 to 300 Pa·s.

23. A process for preparing the ionic silylated copolyurethane of claim 15, said process comprising the sequential steps of:
i. forming a copolyurethane having —NCO end groups, of formula (IV): 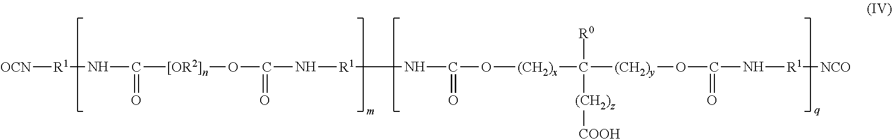
by carrying out a polyaddition reaction between:
a polyisocyanate (A) of formula (IVa): OCN—R¹—NCO (IVa);
a polyether diol (B) of formula (IVb): H—[OR²]ₙ—OH (IVb); and
a carboxylic diol (C) of formula (IVc): 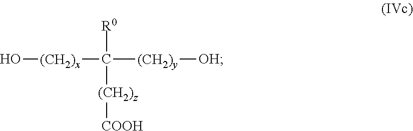
then
ii. reacting the copolyurethane of formula (IV) with an amine (D) of formula (IVd):
N(R)(R′)(R″) (IVd)
to form an ionic copolyurethane having —NCO end groups of formula (V): 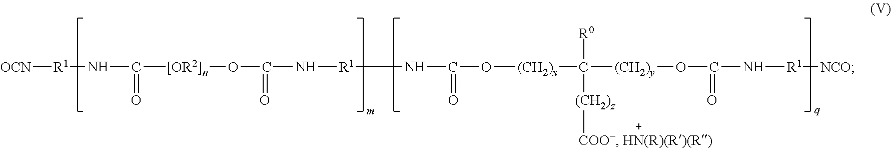
then
iii. reacting the copolyurethane having —NCO end groups of formula (V) with an aminosilane (E) derived from a secondary amine, of formula (VI):

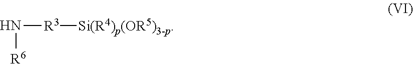

24. A composition, usable as sealant and/or adhesive, comprising:
at least one ionic silylated copolyurethane as defined in claim 15, and
at least one filler.

25. The composition according to claim 24, wherein it comprises:
from 10% to 50% by weight of said copolyurethane, and
from 20% to 60% by weight of the filler; wherein the weight percentages are expressed on the basis of the total weight of said composition.

26. The composition according to claim 24, further comprising at least a moisture-absorbing agent, an adhesion-promoting agent, a plasticizing agent and/or a rheology agent.

27. An article comprising the composition of claim 24 in a hermetic packaging protected from air.

28. A process for assembling two substrates, comprising:
coating the composition of claim 24, in the form of a layer of a thickness between 0.2 and 5 mm, onto at least one of the two substrates to be assembled; then
effectively bringing the two substrates into contact.
